(19) United States
(12) Patent Application Publication
(10) Pub. No.: US 2014/0338789 A1
(43) Pub. Date: Nov. 20, 2014

(54) TREE DELIMBER WITH INFEED POST

(71) Applicant: Caterpillar Forest Products Inc., Peoria, IL (US)

(72) Inventors: James L. Kramer, Phillips, WI (US); Brian P. Anderson, Wausau, WI (US)

(73) Assignee: Caterpillar Forest Products Inc., Peoria, IL (US)

(21) Appl. No.: 14/452,673

(22) Filed: Aug. 6, 2014

(51) Int. Cl. A01G 23/097

(52) U.S. Cl. CPC A01G 23/097
USPC 144/24.13

(57) ABSTRACT

A delimber for performing a delimbing operation is disclosed herein. The delimber includes a cutter head assembly pivotally mounted on a yoke assembly. The yoke assembly is rotatably mounted on a base assembly. The cutter head assembly includes a base portion with a first side and a second side. A box structure is arranged on the first side, whereas a saw assembly is structured and arranged on the second side. The box structure and the saw assembly define a throat region between the two sides. The throat region defines an infeed side and an exit side. At least one curved knife is pivotally supported within the throat region. Further, an elongated post is positioned adjacent the infeed side of the throat region. The infeed post has a first end attached to the box structure, and a second end attached to the base portion.

### TECHNICAL FIELD

The present disclosure relates generally to forest machinery for performing processing operations on a tree. More specifically, the present disclosure relates to a delimber to be used as a forest machinery that removes branches from a tree trunk.

### BACKGROUND

Tree delimbers are commonly known in the forest machine industry to remove branches (limbs) from a tree trunk. Such delimbers generally include a cutter head assembly to perform the delimbing operation. The cutter head assembly includes a throat region, which supports a pair of curved knives pivotable towards each other. As a tree is pulled through the pair of curved knives, the branches and other protrusions are stripped off from the tree trunk.

Generally, a gripping machine, such as a knuckleboom loader, may pick up an individual tree or a bunch of felled trees, place them in the throat region, and pull them through the pair of curved knives. However, during placement of the bunch of trees in the throat region, some trees fall beyond the reach of the curved knives. Those trees may require repetitive effort to be accurately placed in the curved knives, for efficiently performing the delimbing operation.

U.S. Pat. No. 4,899,794 discloses a cutter head assembly of a delimber, in which a tree is pulled through a support frame of the cutter head assembly to perform the delimbing operation. The cutter head assembly includes a pair of curved limb cutting levers, which define a circular opening, through which the tree is pulled. However, the placement of the trees in the support frame may still be disordered, resulting in inefficient operation of the delimber.

### SUMMARY OF THE DISCLOSURE

Various aspects of the present disclosure are directed towards a delimber for removing branches from a tree trunk. The delimber includes a base assembly, a yoke assembly, and a cutter head assembly. The yoke assembly is rotatably mounted on the base assembly. The cutter head assembly is mounted on the yoke assembly and includes a bottom portion, a box structure, a saw assembly, at least one curved knife, and an S-shaped infeed post. The bottom portion has a first side and a second side. The box structure is arranged on the first side of the base portion. The saw assembly is structured and arranged on the second side of the base portion and spaced apart from the box structure. The box structure and the saw assembly define a throat region there between. The throat region has an infeed side and an exit side. The at least one curved knife is pivotally supported in the throat region between the infeed side and the exit side. The infeed post is positioned adjacent the infeed side of the throat region. The infeed post has a first end attached to the box structure, and a second end attached to the base portion.

### BRIEF DESCRIPTION OF DRAWINGS

FIG. 1 is a perspective view of a knuckleboom loader that works in conjunction with a delimber, illustrating a delimbing operation being performed on a tree, in accordance with the concepts of the present disclosure;

FIG. 2 is an enlarged perspective view of the delimber of FIG. 1, illustrating various components of the delimber, in accordance with the concepts of the present disclosure; and

FIG. 3 is a further enlarged view of an infeed post of the delimber of FIG. 1 and FIG. 2, illustrating structural details of the infeed post, in accordance with the concepts of the present disclosure.

### DETAILED DESCRIPTION

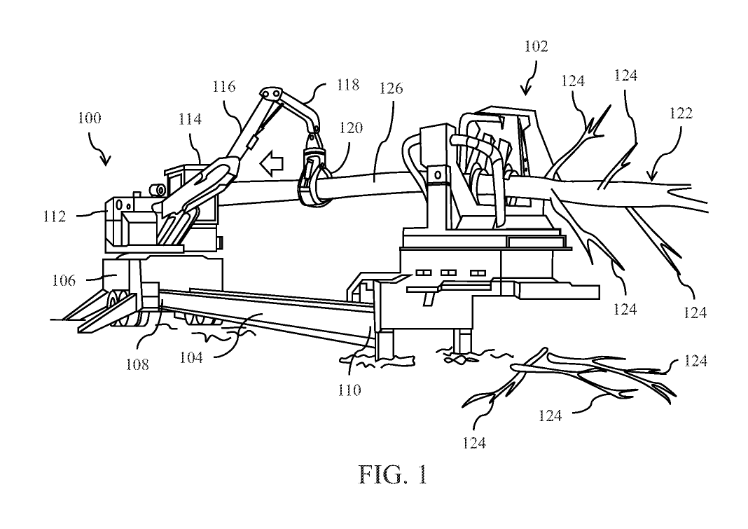

Reference will now be made in detail to specific embodiments or features, examples of which are illustrated in the accompanying drawings. Wherever possible, corresponding or similar reference numbers will be used throughout the drawings to refer to the same or corresponding parts. Referring to FIG. 1, there is shown a perspective view of an exemplary knuckleboom loader 100 that works in conjunction with a delimber 102.

The knuckleboom loader 100 and the delimber 102 are mounted on opposite ends of a trailer unit 104. The knuckleboom loader 100 is mounted on a frame 106 that is bolted to a first end 108 of the trailer unit 104. The delimber 102 is mounted on a second end 110 of the trailer unit 104. Although, the present disclosure shows the knuckleboom loader 100 and the delimber 102 respectively, as mounted on the first end 108 and the second end 110 of the trailer unit 104. It may be contemplated that the delimber 102 may be a standalone unit independent of the knuckleboom loader 100.

The knuckleboom loader 100 includes a prime mover 112 and a cab 114, mounted on the frame 106. As shown in FIG. 1, the prime mover 112 and the cab 114 are mounted at the first end 108 of the trailer unit 104. The cab 114 is provided to house an operator of the knuckleboom loader 100. Moreover, the cab 114 includes control implements that are operable to control the operation of the knuckleboom loader 100.

The prime mover 112 may be a fuel-based engine that powers the knuckleboom loader 100 by combustion of natural resources, such as gasoline, liquid natural gas, and/or other petroleum products. However, in alternative embodiments, the present disclosure may be equally implemented by use of an electric motor in lieu of the fuel-based engine.

The knuckleboom loader 100 further includes a boom 116, a stick 118, and a grapple 120, all of which are mounted in sequence to the frame 106. Due to the placement, the cab 114 and the boom 116 may swivel on top of the frame 106. Additionally, the boom 116 may be operated to pivot vertically with respect to the frame 106. The stick 118 may be vertically hoisted or lowered relative to the boom 116. The boom 116 and the stick 118 facilitate movement of the grapple 120 in various planes relative to the frame 106. Further, the grapple 120 may be articulated about its connection with the stick 118 to move in a multiplicity of orientations, depending on specific requirements of an application.

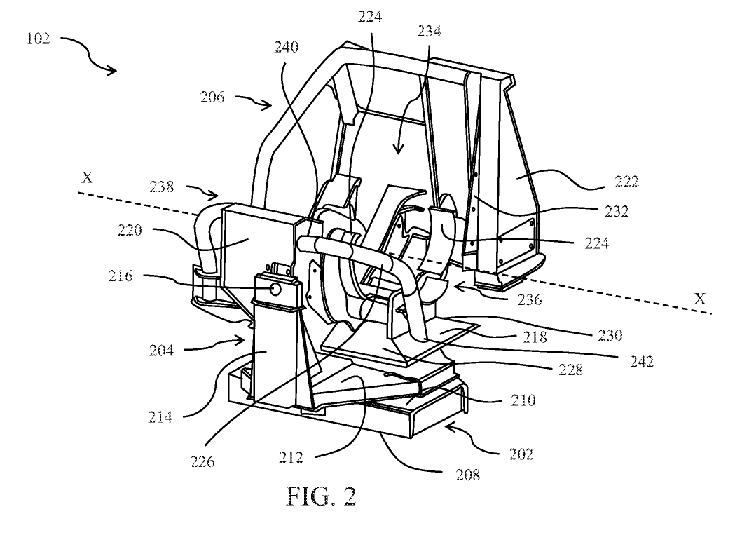

The knuckleboom loader 100 is adapted to pick up a tree 122 felled by other machines, and pull it through the delimber 102, to strip off branches 124 from the tree trunk 126. Although, the knuckleboom loader 100 is shown to process a single tree 122 through the delimber 102, it may be contemplated that the knuckleboom loader 100 may pick a bunch of trees together, and pull it through the delimber 102 to perform the delimbing operation. Further, the assembly and structural details of the delimber 102 are described in FIG. 2.

Referring to FIG. 2, there is shown the delimber 102 of FIG. 1, for performing delimbing operation on the tree 122 fed by the knuckleboom loader 100. The delimber 102 includes a base assembly 202, a yoke assembly 204, and a cutter head assembly 206.

The base assembly 202 may be a cubical box defining a bottom surface 208 and an upper surface 210. The bottom surface 208 is fixedly mounted on the second end 110 of the trailer unit 104 by bolting, riveting, welding, or similar mechanisms, as is customary. The upper surface 210 rotatably supports the yoke assembly 204.

The yoke assembly 204 includes a floor plate 212 and a pair of upright pillars 214. The floor plate 212 is in rotatable engagement with the upper surface 210 of the base assembly 202. The upright pillars 214 extend substantially perpendicular from opposite ends of the floor plate 212. Each of the upright pillars 214 includes a bearing block 216 to pivotally support the cutter head assembly 206.

The structure and arrangement of the base assembly 202, the yoke assembly 204, and the cutter head assembly 206 enables the delimber 102 to receive the tree 122 from the knuckleboom loader 100 (FIG. 1) in a multiplicity of positions. The structural details of the cutter head assembly 206 will be discussed hereafter.

The cutter head assembly 206 is adapted to strip off the branches 124 from the tree trunk 126 (FIG. 1). The cutter head assembly 206 includes a base portion 218, a box structure 220, a saw assembly 222, at least one curved knife 224, and an S-shaped infeed post 226.

The base portion 218 may be a base plate or a rectangular box structure fabricated from a steel plate or similar materials. The base portion 218 includes a first side 228 and a second side 230. The first and second sides 228 and 230 of the base portion 218 respectively provide a mounting base for the box structure 220, and the saw assembly 222.

The box structure 220 is arranged on the first side 228 of the base portion 218 and extends substantially perpendicular to the base portion 218. The box structure 220 may be formed of a sheet metal fabricated by conventional welding methods or similar method thereof

The saw assembly 222 is structured and arranged on the second side 230 of the base portion 218, and spaced apart from the box structure 220. The saw assembly 222 includes a saw blade 232 and associated mechanisms to operate the saw blade 232. The saw blade 232 is positioned to cut the tree tops, once the delimbing operation is finished on trees.

The base portion 218, the box structure 220, and the saw assembly 222 forms a substantially U-shaped structure, through which the tree 122 is passed to be delimbed. The specific structure of the cutter head assembly 206 provides a throat region 234 between the box structure 220 and the saw assembly 222. The throat region 234 has a longitudinal axis X-X, along which the throat region 234 defines an infeed side 236 and an exit side 238.

The curved knives 224 are pivotally mounted within the throat region 234. Although two knives 224 are shown in the present embodiment. It may be contemplated that more than two knives, for example, three, four, or five knives may be included within the delimber 102. Such a configuration may depend on the type of the delimber 102 and/or specific requirements of an application. The curved knives 224 may be operated to open or close substantially around the tree trunk 126 (FIG. 1).

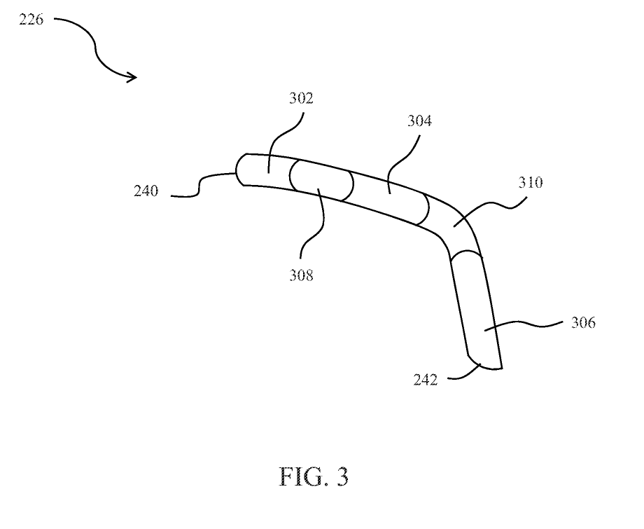

The infeed post 226 is positioned to guide the tree 122, during the delimbing operation. The infeed post is mounted adjacent the infeed side 336 of the throat region 334. The infeed post 226 includes a first end 240 and a second end 242. The first end 240 is attached to the box structure 220. The second end 242 is attached to the base portion 218. Further structural details of the infeed post 226 are described in FIG. 3.

Referring to FIG. 3, there is shown the infeed post 226. The infeed post 226 may be a single, elongated cylindrical rod suitably bent at various sections to form an S-shaped structure. The infeed post 226 is angled towards the curved knives 224 and includes a horizontal portion 302, an inclined portion 304, and a vertical portion 306. An interface between the horizontal portion 302 and the inclined portion 304 forms a first bend 308. Similarly, an interface between the inclined portion 304 and the vertical portion 306 forms a second bend 310.

In orientation and assembly, the infeed post 226 is arranged relative to the other components of the delimber 102 (FIGS. 1 and 2). More particularly, the horizontal portion 302 is paralelly aligned to the base portion 218, along the longitudinal axis X-X, the inclined portion 304 extends towards the curved knives 224, while the vertical portion 306 extends in a direction perpendicular to the base portion 218.

### INDUSTRIAL APPLICABILITY

The delimber 102 of the present disclosure has applicability for implementation and use in industrial settings, such as forestry, agriculture, construction and the like.

During operation, the grapple 120 of the knuckleboom loader 100 may pick up a felled tree 122 or a bunch of trees and place it in the throat region 234 of the delimber 102, while still holding the trees. The trees 122 may enter from an open end of the throat region 234 to be fed into the throat region 234.

Further, the inclined portion 304 of the infeed post 226 guides the trees 122 towards the curved knives 224 as it enters the throat region 234. This enables the trees 122 to be appropriately positioned within the curved knives 224. Such a provision avoids repetitive effort required to accurately position the trees 122 in the curved knives 224.

Once the trees 122 are accurately placed in the curved knives 224, the curved knives 224 close around the tree trunk 126 of the tree 122. Thereafter, the trees 122 are pulled along the longitudinal axis X-X, through the curved knives 224, while the curved knives 224 maintained in a closed position. As the trees 122 are pulled through the curved knives 224, the curved knives 224 shear off the branches 124 from the tree trunk 126. After substantially performing the delimbing operation, the tree tops are cut via the saw blade 232.

As, the infeed post 226 groups the bunch of trees 122 together, the saw blade 232 may simultaneously cut the tops of all trees 122. This leaves naked wood logs behind, which are placed on the trailer unit 104 to be transported to various processing industries.

What is claimed is:

1. A delimber comprising:
a base assembly;
a yoke assembly rotatably mounted on the base assembly;
a cutter head assembly mounted on the yoke assembly, the cutter head assembly comprising:
a base portion having a first side and a second side;
a box structure arranged on the first side of the base portion;
a saw assembly structured and arranged on the second side of the base portion and spaced apart from the box structure;
wherein the box structure and the saw assembly defines a throat region there between, the throat region having an infeed side and an exit side;
at least one curved knife pivotally supported within the throat region between the infeed side and the exit side; and
an S-shaped infeed post positioned adjacent the infeed side of the throat region, the S-shaped infeed post having a first end attached to the box structure, and a second end being attached to the base portion.
